(19) United States
(12) Patent Application Publication
(10) Pub. No.: US 2025/0197677 A1
(43) Pub. Date: Jun. 19, 2025

(54) Two-Part Curable Adhesive Composition

(71) Applicant: Henkel AG & Co. KGaA, Duesseldorf (DE)

(72) Inventor: Tian Li, Shanghai (CN)

(21) Appl. No.: 19/071,827

(22) Filed: Mar. 6, 2025

Related U.S. Application Data
(63) Continuation of application No. PCT/CN2022/117239, filed on Sep. 6, 2022.

(51) Int. Cl. C09J 4/06; B32B 7/12; B32B 15/04; B32B 17/06; B32B 27/06; C09J 11/06; C09J 11/08; C09J 133/12

(52) U.S. Cl. CPC C09J 4/06; B32B 7/12; B32B 15/04; B32B 17/06; B32B 27/06; C09J 11/06; C09J 11/08; C09J 133/12; B32B 2255/26; B32B 2457/00

(57) ABSTRACT

The present invention provides a two-part curable adhesive composition consisting of: Part A comprising: (a) at least one alkyl (meth)acrylate monomer, (b) at least one acrylonitrile-butadiene rubber having an acrylonitrile content of less than 45% by weight, based on the total weight of the acrylonitrile-butadiene rubber, and (c) at least one flexibilizing agent selected from polyester-based urethane (meth)acrylate oligomer and/or (meth)acrylate terminated acrylonitrile-butadiene oligomer; and Part B comprising at least one catalyst.

### TECHNICAL FIELD

The present invention relates to a two-part curable adhesive composition and the use thereof.

### BACKGROUND OF THE INVENTION

Structural adhesives have been widely used in bonding substrates such as metals, plastics, etc. in the manufacturing environment because of fast curing speed and high impact resistance. Generally, structural adhesives are formed from two parts: a composition containing the curing agent (based on acrylate or methacrylate) and a catalyst for curing the adhesive. These two parts are stored in two different compartments and are mixed prior to application of the adhesive. This catalyst is a free-radical polymer initiator, in particular based on peroxide, and is well known in the art. The part containing the curing agent also contains other elements, such as a cure accelerator, a rheology modifier or an adhesion promoter. Such adhesives are in particular described in US 2013/0292054 A1, U.S. Pat. No. 6,602,958 B2, EP 2194105 B1, etc.

When structural adhesives are used in the handheld electronic devices, they may contact people's skin and expose to chemicals such as sweat, grease, cosmetics and etc. on the skin, which may deteriorate the properties of the adhesives. Seldom prior arts have been found to develop the chemical resistance of the structural adhesives. Consequently, there is a need for a two-part curable adhesive composition that exhibits excellent chemical resistance such as oleic acid resistance when cured while maintaining mechanical properties and dispensability.

### SUMMARY OF THE INVENTION

According to a first aspect of the invention, disclosed herein is a two-part curable adhesive composition consisting of:

Part A comprising
(a) at least one alkyl (meth)acrylate monomer,
(b) at least one acrylonitrile-butadiene rubber having an acrylonitrile content of less than 45% by weight, based on the total weight of the acrylonitrile-butadiene rubber, and
(c) at least one flexibilizing agent selected from polyester-based urethane (meth)acrylate oligomer and/or (meth)acrylate terminated acrylonitrile-butadiene oligomer; and
   Part B comprising at least one catalyst.

According to a second aspect of the invention, provided herein is a method for preparing the two-part curable adhesive composition.

According to a third aspect of the invention, provided herein is a laminate, comprising a first substrate, a second substrate, and an adhesive layer sandwiched therebetween, wherein the first and second substrates are independently of each other selected from a glass, a resin and a metal, and the adhesive layer being formed by curing the adhesive composition of the present invention.

According to a fourth aspect of the invention, provided herein is an electronic device, comprising the laminate of the present invention or produced using the adhesive composition according to the present invention.

According to a fifth aspect of the invention, provided herein is the use of the adhesive composition according to the present invention or the laminate according to the present invention in manufacturing electronic devices.

Other features and aspects of the subject matter are set forth in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules.

The term “copolymer” as used herein refers to polymers having more than one monomer unit.

As used herein, the term “oligomer” refers to a low molecular weight polymer comprising repeat units of from 10 to 100.

The term “graft polymer” as used herein refers to a polymer comprising molecules with one or more species of block connected to the main chain as side chains, these side chains having constitutional or configurational features that differ from those in the main chain.

The term “room temperature” as used herein refers to a temperature of about 15° C. to about 35° C., preferably about 25° C.

Unless specified otherwise, the recitation of numerical end points includes all numbers and fractions subsumed within the respective ranges, as well as the recited end points.

All references cited in the present specification are hereby incorporated by reference in their entirety.

The molecular weights refer to weight average molecular weights (Mw), unless otherwise stipulated. All molecular weight data refer to values obtained by gel permeation chromatography (GPC), unless otherwise stipulated, e.g., according to DIN 55672.

In this context, the glass transition temperature (Tg) or the melting point of a specific polymer is determined using DSC according to DIN 53 765.

Unless otherwise defined, all terms used in the present invention, including technical and scientific terms, have the meaning as commonly understood by one of the ordinary skilled in the art to which this invention belongs.

In one aspect, the present disclosure is generally directed to a two-part curable adhesive composition consisting of:

Part A comprising
(a) at least one alkyl (meth)acrylate monomer,
(b) at least one acrylonitrile-butadiene rubber having an acrylonitrile content of less than 45% by weight, based on the total weight of the acrylonitrile-butadiene rubber, and
(c) at least one flexibilizing agent selected from polyester-based urethane (meth)acrylate oligomer and/or (meth)acrylate terminated acrylonitrile-butadiene oligomer; and Part B comprising at least one catalyst.

### Part A:

### (a) Alkyl (Meth) Acrylate Monomer

According to the present invention, Part A comprises at least one alkyl (meth)acrylate monomer.

The alkyl (meth)acrylate ester monomer for Part A may be any alkyl ester of acrylic acid or methacrylic acid known to the art. Examples are esters of C1-C6 monofunctional alcohols with (meth) acrylic acid (such as methyl acrylate, methyl methacrylate, ethyl acrylate or methacrylate, n-propyl or isopropyl acrylate or methacrylate, butyl (meth)acrylates (all isomers)) and hexyl (meth)acrylates, esters of higher molecular weight alcohols having up to 12 carbon atoms (such as lauryl (meth)acrylate, 2-ethylhexyl (meth)acrylate, hexyl (meth)acrylate, isodecyl (meth)acrylate and the like). Part A may also comprise a combination of two or more such monomers. Preferred alkyl (meth)acrylate monomers are esters of C1-C4 monofunctional alcohols with (meth) acrylic acid, and methacrylate esters are particularly preferred. Methyl methacrylate is especially preferred.

Suitable commercially available component (a) can be methyl methacrylate from Lucite International, VISIOMER™ MMA from Evonik and methyl methacrylate from Mitsubishi Chemical.

With particular preference, the alkyl (meth)acrylate monomer (a) may be present in an amount of from 40% to 85% by weight, and preferably from 40% to 70% by weight, based on the total weight of the adhesive composition.

### (b) Acrylonitrile-Butadiene Rubber

According to the present invention, Part A comprises at least one acrylonitrile-butadiene rubber having an acrylonitrile content of less than 45% by weight, based on the total weight of the acrylonitrile-butadiene rubber.

The term acrylonitrile-butadiene rubber (alias as nitrile rubber, also abbreviated to “NBR”) in the context of the present application is to be understood as meaning rubbers which are co-, ter- or quaterpolymers of at least one a, B-ethylenically unsaturated nitrile, at least one conjugated diene and optionally one or more additional copolymerizable monomers. Generally, the weight average molecular weight (Mw) of NBR is around or above 700,000 g/mol.

Preferably, the acrylonitrile-butadiene rubber has an acrylonitrile content of from 10% to 42% by weight, preferably from 20% to 40% by weight, and more preferably from 30% to 40% based on the total weight of the acrylonitrile-butadiene rubber. The more acrylonitrile content is within the acrylonitrile-butadiene rubber, the higher is the resistance to oils but the lower is the flexibility of the material. With such specific range is used, the two-part curable adhesive composition has a balanced properties of chemical resistance and flowability.

Functionalized acrylonitrile-butadiene rubbers are copolymers that have been chemically modified to include one or more functional groups such as hydroxyl, amino, ether, ester, amide, sulfonate, sulfonic acid, carboxyl, or carboxylate group, which can also be used as component (b). The presence of functional groups on the acrylonitrile-butadiene rubbers can facilitate the crosslinking. In an embodiment, the functionalized acrylonitrile-butadiene rubbers include one or more of the functional groups covalently bonded to the backbone of the copolymers, either directly or via a moiety such as an alkyl group.

Derivatives of NBR include carboxylated NBR (XNBR), carboxylated hydrogenated NBR (XHNBR), and NBR with some of the nitrile groups substituted by an amide group (referred to as amidated NBR or ANBR), or a combination comprising at least one of the foregoing.

In some embodiments, the acrylonitrile-butadiene rubber (b) has a glass transition temperature (Tg) of from −15° C. to −45° C., preferably from −30° C. to −35° C.

The acrylonitrile-butadiene rubber suitable for component (b) can be prepared by free-radical copolymerization of butadiene and acrylonitrile in emulsions.

Suitable commercially available acrylonitrile-butadiene rubbers are sold under the Nipol™ DN401L, DN2850, 1052 and 4050 from Zeon Chemicals.

With particular preference, the acrylonitrile-butadiene rubbers may be present in an amount of from 0.1% to 30% by weight, and preferably from 5% to 25% by weight, based on the total weight of the adhesive composition.

### (c) Flexibilizing Agent

According to the present invention, Part A comprises at least one flexibilizing agent selected from polyester-based urethane (meth)acrylate oligomer and/or (meth)acrylate terminated acrylonitrile-butadiene oligomer.

In some embodiments, polyester-based urethane (meth)acrylate oligomer is used as flexibilizing agent in Part A of the present adhesive composition. The polyester-based urethane (meth)acrylate oligomer may be selected from monofunctional polyester-based urethane (meth)acrylate oligomer and/or polyfunctional polyester-based urethane (meth)acrylate oligomer, preferably difunctional polyester-based urethane acrylate oligomer.

The polyester-based urethane (meth)acrylate oligomer may have a weight average molecular weight (Mw) of from 10,000 to less than 40,000 g/mol.

In some embodiments, the polyester-based urethane (meth)acrylate oligomer may be obtained by polyester polyol reacting aliphatic or aromatic isocyanate having two or more isocyanate groups in one molecule and then subjecting the remaining unreacted isocyanate groups to an addition reaction with a hydroxyl group-containing (meth)acrylate monomer. The polyester polyol used to prepare for the polyester-based urethane (meth)acrylate oligomer may be selected from polyethylene adipate diol, polybutylene adipate diol, polyhexamethylene isophthalate adipate diol, 3-methyl-1,5-pentane isophthalate diol, 3-methyl-1,5-pentane terephthalate diol, and polycondensates of 1,6-hexanediol and dimer acid. The aliphatic or aromatic isocyanate having two or more isocyanate groups in one molecule used to prepare for the polyester-based urethane acrylate oligomer may be selected from isophorone diisocyanate, dicyclohexylmethane-4,4-diisocyanate, hexamethylene diisocyanate, aliphatic isocyanate-based compounds including 2,2,4-trimethyl hexanediisocyanate, butenediisocyanate, 1,3-butadiene-1,4-diisocyanate, 2,4,4-trimethylhexamethylene diisocyanate, 1,6,11-undecatriisocyanate, and the like; and bis(isocyanatoethyl)benzene, bis(isocyanatopropyl)benzene, bis (isocyanatobutyl)benzene, bis(isocyanatomethyl) naphthalene, bis(isocyanatomethyl) diphenyl ether, phenylene diisocyanate, ethylphenylene diisocyanate, isopropylphenylene diisocyanate, dimethylphenylene diisocyanate, Diisopropylphenylene diisocyanate, trimethylbenzenetriisocyanate, benzenetriisocyanate, biphenyldiisocyanate, 3,3-dimethoxybiphenyl-4,4-diisocyanate, hexahydrobenzenediisocyanate, hexahydrodiphenylmethane-4,4-diisocyanate, and mixtures thereof. The hydroxyl group-containing (meth)acrylate monomer used to prepare for the polyester-based urethane acrylate oligomer may be selected from 2-hydroxyethyl (meth)acrylate, 4-hydroxybutyl (meth)acrylate, 2-hydroxypropyl (meth)acrylate, 2-hydroxybutyl (meth)acrylate, 6-hydroxyhexyl (meth)acrylate, 1-chloro-2-hydroxypropyl (meth)acrylate, diethylene glycol mono-(meth)acrylate, 1,6-hexanediol mono (meth)acrylate, pentaerythritol tri (meth)acrylate, dipentaerythritol penta (meth)acrylate and the combinations thereof.

Suitable commercially available polyester-based urethane (meth)acrylate oligomers are sold under the BR-7432 GB and BR-741 from BOMAR Specialties LLC, GENOMER 3485 and GENOMER 3611 from RAHN, as well as UX-3204 and UXT-6000 from Nippon kayaku.

As an alternative, (meth)acrylate terminated acrylonitrile-butadiene oligomer can also be used as flexibilizing agent in Part A of the present adhesive composition to achieve the desired effect. The (meth)acrylate terminated acrylonitrile-butadiene oligomer refers to (meth)acrylate groups at both terminals of the acrylonitrile-butadiene copolymer backbone.

There is no limitation on the acrylonitrile content of the (meth)acrylate terminated acrylonitrile-butadiene oligomer used in the present invention, for example, they can have an acrylonitrile content of from 5 to 60%, based on the total weight of the (meth)acrylate terminated acrylonitrile-butadiene oligomer.

In preferred embodiments, the (meth)acrylate terminated acrylonitrile-butadiene oligomer can have a weight average molecule weight (Mw) of less than 200,000 g/mol, more preferably from 3000 to 10000 g/mol.

In preferred embodiments, the (meth)acrylate terminated acrylonitrile-butadiene oligomer can have a viscosity of from 50,000 cps to 1,000,000 cps at ambient temperature.

Suitable commercially available (meth)acrylate terminated acrylonitrile-butadiene oligomer are sold under the Hypro™ 1300X33LC VTBNX and Hypro™ 1300X43LC VTBNX from Huntsman.

In some embodiments, a combination of polyester-based (meth) urethane acrylate oligomer and (meth)acrylate terminated acrylonitrile-butadiene oligomer can be used as flexibilizing agent in Part A of the present adhesive composition.

With particular preference, the flexibilizing agent (c) may be present in an amount of from 0.1% to 20% by weight, and preferably from 5% to 15% by weight, based on the total weight of the adhesive composition.

(d) Core-Shell Graft Polymer Other than Component (b)

According to the present invention, Part A optionally comprises at least one core-shell graft polymer other than component (b). Generally, the component (d) (if present) is non-reactive in the composition which is used to adjust the viscosity and to provide toughness to the adhesive composition when cured.

A core-shell graft polymer for component (d) may be any one of those familiar to those skilled in the art. These materials are particulate graft copolymers having a rubbery or elastomeric core and a hard shell. They swell in the alkyl (meth)acrylate monomer (a) but do not dissolve therein. Typically, so-called “hard” monomers (such as styrene, acrylonitrile or methyl methacrylate) are grafted onto a rubbery core made from polymers of so-called “soft” monomers (such as butadiene or ethyl acrylate). The “core” or backbone polymer of the graft polymers has a glass transition temperature substantially below ambient temperature. The “shell” polymer which is grafted onto the backbone polymer has a glass transition temperature substantially above ambient temperature. Ambient temperature is defined as the temperature range in which the adhesive composition is used.

The core-shell polymers are often referred to by abbreviations of the monomers they contain, useful types being the methacrylate-butadiene-styrene (MBS) graft copolymers, styrene-butadiene-styrene (SBS) graft copolymers, acrylate-styrene-acrylic acid (ASA) graft copolymers, acrylonitrile-butadiene-styrene graft copolymers (ABS) and combinations thereof.

Preferably, the core-shell graft polymer comprises a shell derived from a methacrylate polymer or copolymer. The MBS type of core-shell graft polymer is preferred.

Suitable commercially available core-shell graft polymers are sold under the Kane Ace™ FM50 from KANEKA BELGIUM NV, KANE ACE™ M-521 and KANE ACE™ B-564 from KANEKA, S-2030 and C-223A from Mitsubishi Chemical.

With particular preference, the core-shell graft polymer (d) may be present in an amount of from 0.1% to 30% by weight, and preferably from 5% to 20% by weight, based on the total weight of the adhesive composition.

### Additive

Part A can optionally comprise at least one additive selected from adhesion promoter, inhibitor, chelating agent, reducing agent, thixotropic agent, and combinations thereof.

The adhesion promoter can enhance the adhesion of the composition to the substrates. Suitable examples can be organic acids, carboxylic acids and methacrylated phosphate esters. Exemplary carboxylic acids include methacrylic acid, maleic acid, acrylic acid, fumaric acid, malonic acid and combinations thereof. Exemplary methacrylated phosphate esters include 2-hydroxyethyl methacrylate phosphate, phosphate esters of polyethylene glycol monomethacrylate, ethylmethacrylate phosphate and combinations thereof. Commercial product of the adhesion promoter is available under Harcryl 1228 from Harcros Chemicals. If present, the adhesion promotor may be present in an amount of from 0.1% to 15% by weight, more preferably from 0.1 to 10% by weight, based on the total weight of the adhesive composition.

The reducing agent can be the enforcement of the catalyst. Suitable examples can be selected from tertiary amines and aldehyde amine reaction products. Useful tertiary amines include N,N-dimethylaniline, N, N-dimethyltoluidine, N,N-dimethylaniline, p-tolyldiethanolamine, and combinations thereof. Commercial product of reducing agent such as N,N-Dimethyl-P-toluidine is available from RSA Corporation. If present, the reducing agent may be present in an amount of from 0.5% to 5% by weight, more preferably from 1% to 2% by weight, based on the total weight of the adhesive composition.

The inhibitor can prolong the storage life of the adhesive composition and to provide a desirable working time. The suitable examples are hydroquinone, methyl hydroquinone, para-naphthoquinone and combinations thereof. Commercial product of inhibitor such as methylhydroquinone is available from Sigma Aldrich. If present, the inhibitor may be present in an amount of from 0.01% to 1% by weight, more preferably from 0.01% to 0.1% by weight, based on the total weight of the adhesive composition.

Thixotropic agents can be used to modify the viscosity of the adhesive composition. The suitable thixotropic agent is fumed silica. Commercial product of fumed silica is available under Aerosil 200 from Evonik. If present, the thixotropic agent may be present in an amount of from 0.1% to 5% by weight, more preferably from 0.1% to 2% by weight, based on the total weight of the adhesive composition.

Chelating agent can be used to chelate the metal ions in the adhesive to prevent premature curing and improve the storage stability. The suitable chelating agent can be Ethylene Diamine Tetraacetic Acid (EDTA). Commercial product of the chelating agent is Versene 220 from Dow. If present, the chelating agent may be present in an amount of from 0.01% to 1% by weight, more preferably from 0.01% to 0.5% by weight, based on the total weight of the adhesive composition.

### Part B Catalyst

According to the present invention, Part B comprises at least one catalyst suitable for accelerating the curing and/or crosslinking of part A.

Suitable catalyst used in the present invention include benzoyl peroxide, cumene hydroperoxide, tertiary butyl hydroperoxide, dicumyl peroxide, tertiary butyl peroxide acetate, tertiary butyl perbenzoate, ditertiary butyl azodiisobutyronitrile, and combinations thereof.

With particular preference, the catalyst may be present in an amount of from 0.1% to 20% by weight, and preferably from 1% to 10% by weight, based on the total weight of the adhesive composition.

### Adhesive Composition

The mixing ratio between Part A and Part B can be from 1:1 to 20:1, preferably from 4:1 to 10:1 by weight.

In a particular preferred embodiment, a two-part curable adhesive composition, based on the total weight of the adhesive composition, comprising:
from 40% to 85% by weight, and preferably from 40% to 70% by weight of at least alkyl (meth)acrylate monomer (a);
from 0.1% to 30% by weight, and preferably from 5% to 25% by weight of at least one acrylonitrile-butadiene rubber (b) having an acrylonitrile content of less than 45% by weight, based on the total weight of the acrylonitrile-butadiene rubber;
from 0.1% to 20% by weight, and preferably from 5% to 15% by weight of the flexibilizing agent (c) selected from polyester-based urethane (meth)acrylate oligomer or (meth)acrylate terminated acrylonitrile-butadiene oligomer;
from 0.1% to 30% by weight, and preferably from 5% to 20% by weight of at least one core-shell graft polymer (d) other than component (b);
from 0.1% to 15% by weight, preferably from 0.1 to 10% by weight of at least one adhesion promotor;
from 0.5% to 5% by weight, more preferably from 1% to 2% by weight of at least one reducing agent;
from 0.01% to 1% by weight, more preferably from 0.01% to 0.1% by weight of at least one inhibitor;
from 0.1% to 5% by weight, more preferably from 0.1% to 2% by weight of at least one thixotropic agent;
from 0.01% to 1% by weight, more preferably from 0.01% to 0.5% by weight of at least one chelating agent; and
from 1% to 20% by weight of at least one catalyst.

### Preparation Method

The two-part curable adhesive composition according to the present invention can be prepared by steps as follows to obtain the composition:
(i) adding inhibitor and chelating agent if present, to the component (a);
(ii) dissolving the component (b) into the above mixtures by mixing until a homogeneous solution is obtained;
(iii) adding the component (d) if present, and stirring until a smooth paste is obtained;
(iv) adding the component (c) and other additives if present, into the above paste and mixing until all the components are dispersed to obtain Part A; and
(v) preparing and storing the catalyst (Part B) separately and mixing with Part A prior to use.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the two-part curable adhesive composition is not particularly limited, as long as a composition in which the above-described components are uniformly mixed.

### Laminate and Electronic Device

According to a third aspect of the invention, provided herein is a laminate, comprising a first substrate, a second substrate, and an adhesive layer sandwiched therebetween, wherein the first and second substrates are independently of each other selected from a glass, a resin and a metal, and the adhesive layer being formed by curing the adhesive composition of the present invention.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

In preferred embodiments, at least one of the substrates can be selected from metals, such as metal firing pastes, aluminum, tin, molybdenum, silver, conductive metal oxides such as indium tin oxide (ITO), fluorine doped tin oxide, aluminum doped zinc oxide etc., glasses such as inked glass, bare glass, resins such as polycarbonate, polybutylece terephthalate and polyamide. Further suitable metals include copper, gold, palladium, platinum, aluminum, indium, silver coated copper, silver coated aluminum, tin, and tin coated copper. Preferably both substrates are selected from one of the aforementioned materials.

The two-part curable adhesive composition of the present invention can cure at room temperature within the range of from 15° C. to 35° C. for from 1 to 3 days.

As will be understood, the time and temperature curing profile for each two-part curable adhesive composition will vary, and different compositions can be designed to provide the curing profile that will be suited to the particularly industrial manufacturing process.

According to a fourth aspect of the invention, provided herein is an electronic device, comprising the laminate of the present invention or produced using the adhesive composition according to the present invention.

The two-part curable adhesive composition of the present invention can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The two-part curable adhesive composition can be applied as a continuous or discontinuous coating, in a single or multiple layers and combinations thereof.

### Use

According to a fifth aspect of the invention, provided herein is the use of the adhesive composition according to the present invention or the laminate according to the present invention in manufacturing electronic devices.

The said suitable electronic devices includes, but not limited to, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, or other electronic components.

### Examples

The following examples are intended to assist one skilled in the art to better understand and practice the present invention. The scope of the invention is not limited by the examples but is defined in the appended claims. All parts and percentages are based on weight unless otherwise stated.

### Raw Materials:

Methyl methacrylate is available from Lucite International.

Nipol™ DN401L is acrylonitrile-butadiene rubber having an acrylonitrile content of 19% by weight, available from Zeon.

Nipol™ DN2850 is acrylonitrile-butadiene rubber having an acrylonitrile content of 28% by weight, available from Zeon.

Nipol™ 1052 is acrylonitrile-butadiene rubber having an acrylonitrile content of 33% by weight, available from Zeon.

Nipol™ 4050 is acrylonitrile-butadiene rubber having an acrylonitrile content of 40% by weight, available from Zeon.

Nipol™ 4580 is acrylonitrile-butadiene rubber having an acrylonitrile content of 45% by weight, available from Zeon.

Hypro™ 1300X33LC VTBNX is methacrylate terminated acrylonitrile-butadiene oligomer, available from Huntsman.

Hypro™ 2000X168LC is methacrylate terminated polybutadiene, available from Huntsman.

BR641D is polybutadiene urethane acrylate oligomer, available from BOMAR Specialties LLC.

BR204 is polyether-based urethane acrylate oligomer, available from BOMAR Specialties LLC.

BR7432 GB is polyester-based urethane acrylate oligomer, available from BOMAR Specialties LLC.

Kane Ace™ FM50 is acrylic core shell polymer, available from KANEKA BELGIUM NV.

Methacrylic acid is adhesive promoter, available from Röhm.

Harcryl 1228 is adhesive promoter, available from Harcros Chemicals.

Methylhydroquinone is inhibitor, available from Sigma Aldrich.

VERSENE™ 220E is tetrasodium ethylenediaminetetraacetate tetrahydrate-based chelating agent, available from DOW.

N,N-dimethyl-p-toluidine is reducing agent, available from RSA Corporation.

Aerosil 200 is fumed silica, available from Evonik.

Perkabox GB-50 is dibenzoyl peroxide 50% in phthalate-free carrier, available from Nouryon.

### Test Methods:

### Viscosity:

The viscosity in the present invention was measured at a temperature range at 25° C. with a 27#

spindle, and a Brookfield viscometer. The viscosity less than 25000 mPa-s can be acceptable.

### Part a Stability's Test:

After mixing all components of Part A, the examples and comparative examples were visually observed. If a homogeneous composition was observed, the example was recorded as “stable”, otherwise recorded as “phase separation”. Only “stable” can be acceptable.

### Test Samples Preparation

Each testing specimen was made by two cleaned polyamine (PA) plastic sheets having different size (the large sheet with a hole in the center had a dimension of 40 mm in width and length and 3 mm in thickness; and the small sheet has a dimension of 30 mm in width and length and 3 mm in thickness), glass bead with diameter of 0.127 mm and two-part curable adhesive of the present invention/comparative examples.

Firstly, F the PA sheets were wiped and cleaned with isopropanol. Then two-part curable composition was mixing by a dispenser and the adhesive bead was dispensed on the large PA sheet around the hole of sufficient quantity such that a bonding area of 275 mm² can be formed when mating another small PA sheet; then some glass beads were scattered on the bond line to work as the gap controller; After that, the small PA sheet was placed onto the adhesive to ensure the effective bonding area was 275 mm² and the excess adhesive was removed around the hole; the assembly was clamped until the adhesive cured under condition of 23° C. and 50% relative humidity for 24 hours.

### Push-Out Strength Test

The push-out strength test was performed using a universal testing machine with a punch at 23±2° C. and 50%+5% relative humidity. The punch applied a compressing force on the small sheet through the hole of the large sheet at a pushing speed of 2 mm/min till the assembly can no longer support a load. The maximum load was recorded, and the push-out strength was calculated from dividing the maximum load by the bonding area.

### Oleic Acid Resistance Test

The test sample was prepared according to the above method and cured for 24 hours, then 100% pure oleic acid was applied using a transfer pipet along the edges of the overlap bond such that capillary action drew the oleic acid to the center of the sample. The oleic acid should completely fill any empty space around the adhesive. Then the sample was aged under a condition of 65° C. and 90% relative humidity for 300 hours. The aged sample was taken out and put under room temperature, after 2 hours, push-out strength was tested according to the above method using the aged sample.

### Retention Rate of the Push-Out Strength

Retention rate was calculated according to the following equation:

$$Retention rate = ( push - out strength after aging / push - out strength before aging ) ⋆ 100 \% .$$

A retention rate of greater than 50% can be acceptable, greater than 70% is preferred.

### Examples 1 to 12 (Ex. 1 to Ex. 12) and Comparative Examples 1 to 4 (CEx. 1 to CEx. 4)

Adhesives were prepared with the following method using components in amounts (parts by weight) listed in the Table 1 and 2, the testing samples were prepared stated above as well as the properties were tested using the methods stated above, and the results of evaluations are shown in Table 1 and 2.

### Preparation Method:

All the examples and comparative examples were prepared by steps as follows:
(i) adding inhibitor and chelating agent to alkyl (meth)acrylate monomer (a);
(ii) dissolving the acrylonitrile-butadiene rubber (b) into the above mixtures by mixing until a homogeneous solution was obtained;
(iii) adding the core-shell graft polymer (d) and stirring until a smooth paste was obtained;
(iv) adding the flexibilizing agent (c) and other additives into the above paste and mixing until all the components were dispersed, obtaining Part A; and
(v) mixing with catalyst (Part B) prior to use.

TABLE 1

| | | | | | | Com. |
|---|---|---|---|---|---|---|
| Part | Components (g) | EX. 1 | EX. 2 | EX. 3 | EX. 4 | EX. 1 |
| Part A | Methyl methacrylate | 59.05 | 59.05 | 59.05 | 59.05 | 59.05 |
| | Nipol ™ DN401L | 10.5 | 0 | 0 | 0 | 0 |
| | Nipol ™ DN2850 | 0 | 10.5 | 0 | 0 | 0 |
| | Nipol ™ 1052 | 0 | 0 | 10.5 | 0 | 0 |
| | Nipol ™ 4050 | 0 | 0 | 0 | 10.5 | 0 |
| | Nipol ™ 4580 | 0 | 0 | 0 | 0 | 10.5 |
| | Hypro ™ 1300X33LC | 5 | 5 | 5 | 5 | 5 |
| | VTBNX | | | | | |
| | Kane Ace ™ FM50 | 16.3 | 16.3 | 16.3 | 16.3 | 16.3 |
| | Methacrylic acid | 5.5 | 5.5 | 5.5 | 5.5 | 5.5 |
| | Harcryl 1228 | 1 | 1 | 1 | 1 | 1 |
| | Methylhydroquinone | 0.05 | 0.05 | 0.05 | 0.05 | 0.05 |
| | VERSENE ™ 220E | 0.1 | 0.1 | 0.1 | 0.1 | 0.1 |
| | N,N-dimethyl-p- | 1.5 | 1.5 | 1.5 | 1.5 | 1.5 |
| | toluidine | | | | | |
| | Aerosil 200 | 1 | 1 | 1 | 1 | 1 |
| Part B | Perkabox GB-50 | 10 | 10 | 10 | 10 | 10 |

| | | | | | |
|---|---|---|---|---|---|
| Total weight (g) | 110 | 110 | 110 | 110 | 110 |

Testing results

| | | | | | |
|---|---|---|---|---|---|
| Viscosity (mPa · s) | 14900 | 18300 | 18300 | 24600 | N/A |
| Push-out strength | 14.9 | 16.5 | 17.5 | 9.02 | N/A |
| before oleic acid exposure | | | | | |
| (MPa) | | | | | |
| Push-out strength | 8.55 | 12.9 | 13.9 | 7.63 | N/A |
| after oleic acid exposure at | | | | | |
| 65° C./90% R.H. for 300 hours | | | | | |
| (MPa) | | | | | |
| Retention Rate (%) | 57.4 | 78.2 | 79.4 | 84.6 | N/A |
| Part A's stability | Stable | Stable | Stable | Stable | Phase |
| | | | | | separation |

N/A refers to that the tests were not applicable as Part A exhibited phase separation.

TABLE 2

| | | Com. | Com. | Com. | | | | | | | | |
|---|---|---|---|---|---|---|---|---|---|---|---|---|
| | Components | EX. | EX. | EX. | EX. | EX. | EX. | EX. | Ex. | Ex. | Ex. | Ex. |
| Part | (g) | 2 | 3 | 4 | 5 | 6 | 7 | 8 | 9 | 10 | 11 | 12 |
| Part A | Methyl | 59.05 | 59.05 | 59.05 | 59.05 | 59.05 | 56.2 | 53.2 | 50.35 | 56.2 | 53.2 | 50.35 |
| | methacrylate | | | | | | | | | | | |
| | Nipol ™ 1052 | 10.5 | 10.5 | 10.5 | 10.5 | 10.5 | 10 | 9.5 | 9 | 10 | 9.5 | 9 |
| | Hypro ™ | 5 | 0 | 0 | 0 | 0 | 0 | 0 | 0 | 0 | 0 | 0 |
| | 2000X168LC | | | | | | | | | | | |
| | BR641D | 0 | 5 | 0 | 0 | 0 | 0 | 0 | 0 | 0 | 0 | 0 |
| | BR204 | 0 | 0 | 5 | 0 | 0 | 0 | 0 | 0 | 0 | 0 | 0 |
| | BR7432GB | 0 | 0 | 0 | 5 | 0 | 0 | 0 | 0 | 9.5 | 14.2 | 19 |
| | Hypro ™ | 0 | 0 | 0 | 0 | 5 | 9.5 | 14.2 | 19 | 0 | 0 | 0 |
| | 1300X33LC | | | | | | | | | | | |
| | VTBNX | | | | | | | | | | | |
| | Kane Ace ™ | 16.3 | 16.3 | 16.3 | 16.3 | 16.3 | 15.5 | 14.7 | 13.5 | 15.5 | 14.7 | 13.5 |
| | FM50 | | | | | | | | | | | |
| | Methacrylic | 5.5 | 5.5 | 5.5 | 5.5 | 5.5 | 5.3 | 5.05 | 4.8 | 5.3 | 5.05 | 4.8 |
| | acid | | | | | | | | | | | |
| | Harcryl 1228 | 1 | 1 | 1 | 1 | 1 | 1 | 1 | 1 | 1 | 1 | 1 |
| | Methylhydro- | 0.05 | 0.05 | 0.05 | 0.05 | 0.05 | 0.05 | 0.05 | 0.05 | 0.05 | 0.05 | 0.05 |
| | quinone | | | | | | | | | | | |
| | VERSENE ™ | 0.1 | 0.1 | 0.1 | 0.1 | 0.1 | 0.1 | 0.1 | 0.1 | 0.1 | 0.1 | 0.1 |
| | 220E | | | | | | | | | | | |
| | N,N- | 1.5 | 1.5 | 1.5 | 1.5 | 1.5 | 1.4 | 1.3 | 1.2 | 1.4 | 1.3 | 1.2 |
| | Dimethyl-P- | | | | | | | | | | | |
| | toluidine | | | | | | | | | | | |
| | Aerosil 200 | 1 | 1 | 1 | 1 | 1 | 0.95 | 0.9 | 1 | 0.95 | 0.9 | 1 |
| Part B | Perkabox | 10 | 10 | 10 | 10 | 10 | 10 | 10 | 10 | 10 | 10 | 10 |
| | GB-50 | | | | | | | | | | | |

| | | | | | | | | | | | |
|---|---|---|---|---|---|---|---|---|---|---|---|
| Total weight | 110 | 110 | 110 | 110 | 110 | 110 | 110 | 110 | 110 | 110 | 110 |

Testing results

| | | | | | | | | | | | |
|---|---|---|---|---|---|---|---|---|---|---|---|
| Viscosity (mPa · s) | N/A | N/A | N/A | 23200 | 18300 | 17100 | 14700 | 12900 | 21600 | 18500 | 16700 |
| Push-out strength | N/A | N/A | N/A | 16.3 | 17.5 | 23.9 | 16.6 | 13.4 | 22.1 | 18.3 | 13.9 |
| before oleic acid | | | | | | | | | | | |
| exposure (MPa) | | | | | | | | | | | |
| Push-out strength | N/A | N/A | N/A | 12.8 | 13.9 | 17.6 | 12.5 | 9.8 | 16.9 | 13.5 | 10.1 |
| after oleic acid | | | | | | | | | | | |
| exposure at 65° C./ | | | | | | | | | | | |
| 90% R.H. for 300 | | | | | | | | | | | |
| hours (MPa) | | | | | | | | | | | |
| Retention Rate (%) | N/A | N/A | N/A | 78.5 | 79.4 | 73.6 | 75.3 | 73.1 | 76.5 | 73.8 | 72.7 |
| Part A's stability | Phase | Phase | Phase | Stable | Stable | Stable | Stable | Stable | Stable | Stable | Stable |
| | sepa- | sepa- | sepa- | | | | | | | | |
| | ration | ration | ration | | | | | | | | |

As can be seen from Tables 1 and 2, the compositions having component (b) with an acrylonitrile content out of the claimed range or a different flexibilizing agent than the present invention had either phase separation to lack of workability or unsatisfactory oleic chemical resistant performance.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A two-part curable adhesive composition comprising:
Part A comprising
(a) at least one alkyl (meth)acrylate monomer,
(b) at least one acrylonitrile-butadiene rubber having an acrylonitrile content of less than 45% by weight, based on the total weight of the acrylonitrile-butadiene rubber, and
(c) at least one flexibilizing agent selected from polyester-based urethane (meth)acrylate oligomer and/or (meth)acrylate terminated acrylonitrile-butadiene oligomer; and
Part B comprising at least one catalyst.

2. The two-part curable adhesive composition according to claim 1, wherein the composition optionally comprises (d) at least one core-shell graft polymer other than component (b).

3. The two-part curable adhesive composition according to claim 1, wherein the at least one alkyl (meth)acrylate monomer (a) is selected from esters of C1-C6 monofunctional alcohols with (meth) acrylic acid.

4. The two-part curable adhesive composition according to claim 1, wherein the acrylonitrile-butadiene rubber (b) has an acrylonitrile content of from 10% to 42% by weight based on the total weight of acrylonitrile-butadiene rubber.

5. The two-part curable adhesive composition according to claim 1, wherein the acrylonitrile-butadiene rubber (b) has a glass transition temperature (Tg) from −15° C. to −45° C.

6. The two-part curable adhesive composition according to claim 1, wherein the at least one flexibilizing agent (c) has a molecule weight of less than 200,000 g/mol.

7. The two-part curable adhesive composition according to claim 1, wherein the polyester-based urethane (meth)acrylate oligomer is selected from monofunctional polyester-based urethane (meth)acrylate oligomer and/or polyfunctional polyester-based urethane (meth)acrylate oligomer.

8. The two-part curable adhesive composition according to claim 1, wherein the polyester-based urethane (meth)acrylate oligomer has a weight average molecular weight (Mw) of from 10,000 to less than 40,000 g/mol.

9. The two-part curable adhesive composition according to claim 1, wherein the core-shell graft polymer (d) is selected from methacrylate-butadiene-styrene (MBS) graft copolymers, styrene-butadiene-styrene (SBS) graft copolymers, acrylate-styrene-acrylic acid (ASA) graft copolymers, acrylonitrile-butadiene-styrene graft copolymers (ABS) and combinations thereof.

10. The two-part curable adhesive composition according to claim 1, wherein the part A further comprises additive selected from adhesion promoter, inhibitor, chelating agent, reducing agent, thixotropic agent, and combinations thereof.

11. The two-part curable adhesive composition according to claim 1, wherein the catalyst in part B is selected from benzoyl peroxide, cumene hydroperoxide, tertiary butyl hydroperoxide, dicumyl peroxide, tertiary butyl peroxide acetate, tertiary butyl perbenzoate, ditertiary butyl azodiisobutyronitrile, and combinations thereof.

12. A method for preparing a two-part curable adhesive composition according to claim 1 comprising the steps:
(i) adding inhibitor and chelating agent if present, to the component (a);
(ii) dissolving the component (b) into the above mixtures by mixing until a homogeneous solution is obtained;
(iii) adding the component (d) if present, and stirring until a smooth paste is obtained;
(iv) adding the component (c) and other additives if present, into the above paste and mixing until all the components are dispersed to obtain Part A; and
(v) preparing and storing the catalyst (Part B) separately and mixing with Part A prior to use.

13. A laminate, comprising a first substrate, a second substrate, and an adhesive layer sandwiched therebetween, wherein the first and second substrates are independently of each other selected from a glass, a resin and a metal, and the adhesive layer being formed by curing the adhesive composition according to claim 1.

14. An electronic device, comprising the laminate of claim 13.
